(19) United States
(12) Patent Application Publication
(10) Pub. No.: US 2009/0006259 A1
(43) Pub. Date: Jan. 1, 2009

(54) METHOD OF VERIFYING THAT AN UP-TO-DATE SOFTWARE LICENSE KEY IS NOT OVERWRITTEN BY AN OUTDATED SOFTWARE LICENSE KEY

(76) Inventor: TEH-LI HSI, Florham Park, NJ (US)

Correspondence Address: MARK W. SINCELL;Williams, Morgan & Amerson, P.C., Suite 1100, 10333 Richmond, Houston, TX, 77042, US

(21) Appl. No.: 11/769,100

(22) Filed: Jun. 27, 2007

(51) Int. Cl. H04L 9/00

(52) U.S. Cl. 705/59

(57) ABSTRACT

The present invention provides a method of verifying that an up-to-date software license key is not overwritten by an out of date software license key. One embodiment of the method includes transmitting a first software license key and a first timestamp towards a network element that has software installed thereon. The first software license key includes information used to enable a portion of the functionality of the software. The network element is configured to install the first software license key when the first timestamp indicates a time later than a second timestamp associated with a second software license key installed on the network element.

### BACKGROUND OF THE INVENTION

1. Field of the Invention

This invention relates generally to communication system software, and, more particularly, to software licensing keys used in communication system software.

2. Description of the Related Art

Conventional wireless communication systems include numerous hardware components that function together to provide wireless connectivity to mobile units. Software is installed on each of the hardware components to enable the hardware components to perform the many functions necessary to provide wireless connectivity. Service providers purchase the hardware components from equipment manufacturers or suppliers. The software may come pre-installed on the hardware components or may be purchased from the equipment manufacturer or a separate software vendor. The service provider may also purchase a software license key that must be installed on the hardware component for the associated software to function correctly. The software license key may also include information that may be used to configure the software, such as information that may be used to enable some portions of the functionality of the software and to disable other portions of the functionality of the software. Once the service provider has purchased a software license key, the service provider may pay a subscription fee or service charge to maintain the software license key. The subscription fee or service charge may be determined by the level of service enabled by the software license key.

To simplify the development and distribution of the hardware components and the associated software, equipment manufacturers and/or software developers typically create hardware components and software that are capable of providing a full range of functionality to a predetermined capacity. However, not all service providers need or want to implement the full functionality and/or capacity of the hardware components and/or the software. Service providers may therefore purchase software license keys that limit the functionality and/or capacity of the hardware components and/or the software. For example, the hardware and/or software used to implement a network element such as a base station may be capable of supporting voice and data wireless communication for several hundred mobile units. However, the service provider may know that a particular geographic area only requires a base station that can serve approximately 10 mobile units at a time. The service provider may therefore purchase the base station and a software license key that permits the base station to serve a maximum of 15 mobile units at a time. The software license key (and the associated subscription fee or service charge) for a limited number of users may be significantly less expensive than a software license key that would enable the base station to function at its maximum capacity.

Service providers may also modify the functionality of the hardware and/or the software components by purchasing different software license keys. For example, a service provider may initially purchased a base station and a software license key that permits the base station to serve a maximum of 15 mobile units at a time. Over time the service provider may discover that demand for wireless connectivity in the region served by the base station is larger than expected. The service provider may then purchase a new software license key that enables the base station to serve a larger number of mobile units. Conversely, the service provider may discover that the demand for wireless connectivity in the region served by the base station and a smaller than expected. In that case, the service provider may purchase a new software license key that limits the base station to serving a smaller number of mobile units.

Unscrupulous service providers can exploit this system to obtain software license keys that enable a relatively large portion of the hardware and/or software component functionality and/or capacity at the cost of a software license key that limits the hardware and/or software component functionality and/or capacity to a relatively low level. For example, a service provider may initially purchase a first software license key that enables full functionality of the hardware and/or software components at the full capacity. The service provider then begins paying the subscription fee for the first software license key. The service provider may then purchase a second software license key that disables a portion of the functionality of the hardware and/or software components or reduces the capacity supported by the hardware and/or software components. The second software license key may be installed on the appropriate hardware component and the service provider may begin paying the relatively smaller subscription fee. However, an unscrupulous service provider may keep a copy of the first software license key and install this copy to re-enable the full functionality and/or capacity of the hardware and/or software components without notifying the equipment provider or software developer. Thus, the unscrupulous service provider may be able to operate the hardware and/or software components at full capacity while paying the reduced subscription fee.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for verifying that an up-to-date software license key is not overwritten by an out of date software license key. One embodiment of the method includes transmitting a first software license key and a first timestamp towards a network element that has software installed thereon. The first software license key includes information used to enable a portion of the functionality of the software. The network element is configured to install the first software license key when the first timestamp indicates a time later than a second timestamp associated with a second software license key installed on the network element.

In one embodiment of the present invention, a method is provided for verifying that an up-to-date software license key is not overwritten by an out of date software license key. One embodiment of the method includes receiving a first software license key and a first timestamp associated with software. The first software license key includes information used to enable a portion of the functionality of the software. The method also includes installing the first software license key when the first timestamp indicates a time later than a second timestamp associated with a previously installed second software license key associated with the software.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a communication system, in accordance with the present invention;

FIG. 2 conceptually illustrates one exemplary embodiment of a software license key, in accordance with the present invention;

FIG. 3 conceptually illustrates one exemplary embodiment of a method of determining whether to install a software license key on a network element, in accordance with the present invention; and

FIG. 4 conceptually illustrates one exemplary embodiment of a token, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, electromagnetic waves, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

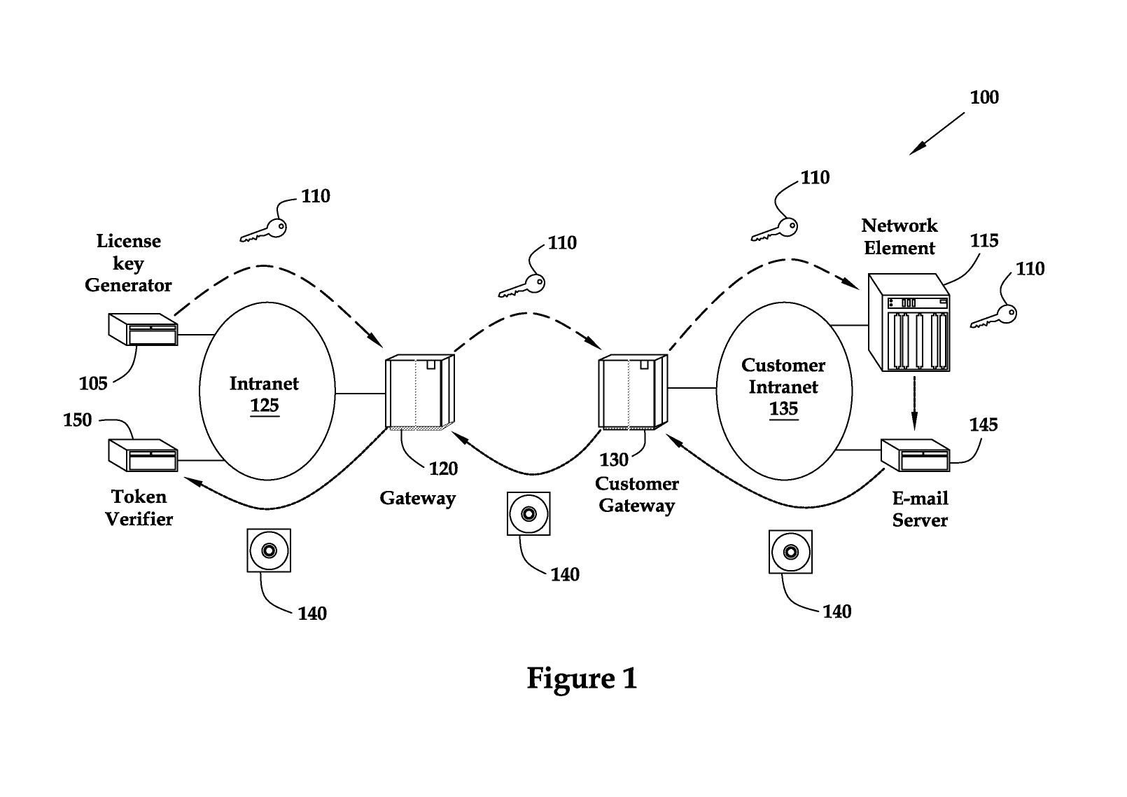

FIG. 1 conceptually illustrates one exemplary embodiment of a communication system 100. In the illustrated embodiment, the communication system 100 includes numerous elements that are used to provide software license keys that enable selected functionality of various hardware and/or software components, as will be discussed in detail below. Elements of the communication system 100 may also be used to install the software license keys and to verify that the software license keys were correctly installed, as will be discussed in detail below. The elements of the communication system 100 described herein may be implemented in hardware, firmware, software, or any combination thereof. Furthermore, the specific elements depicted in FIG. 1 are intended to be illustrative of one embodiment of the communication system 100. However, persons of ordinary skill in the art having benefit of the present disclosure should appreciate that other embodiments of the communication system 100 may implement more, fewer, and/or different elements that are shown in FIG. 1.

The communication system 100 includes a license key generator 105 that is used to generate one or more software license keys 110. The software license keys 110 are configured to enable full or partial functionality of software installed on a network element 115. In the illustrated embodiment, the network element 115 is a part of a Code Division Multiple Access (CDMA) wireless communication network. The software installed on the network element 115 may therefore be used to implement functions related to providing wireless connectivity to one or more mobile units (not shown) in the CDMA wireless communication network. The software license keys 110 may be configured to permit the software installed on the network element 115 to perform one or more functions related to providing wireless connectivity for a selected capacity. The total capacity supported by the network element 115 and associated software may be expressed in terms of a number of mobile units, bandwidths for forward and/or reverse link traffic, bandwidths for voice and/or data traffic, or in any other fashion. For example, the network element 115 and the associated software may be capable of providing a total bandwidth of 100 MBps. The software license keys 110 may then enable full capacity (e.g., transmissions up to the bandwidth of 100 MBps) or a reduced capacity (e.g., transmissions up to a bandwidth of approximately 10 MBps).

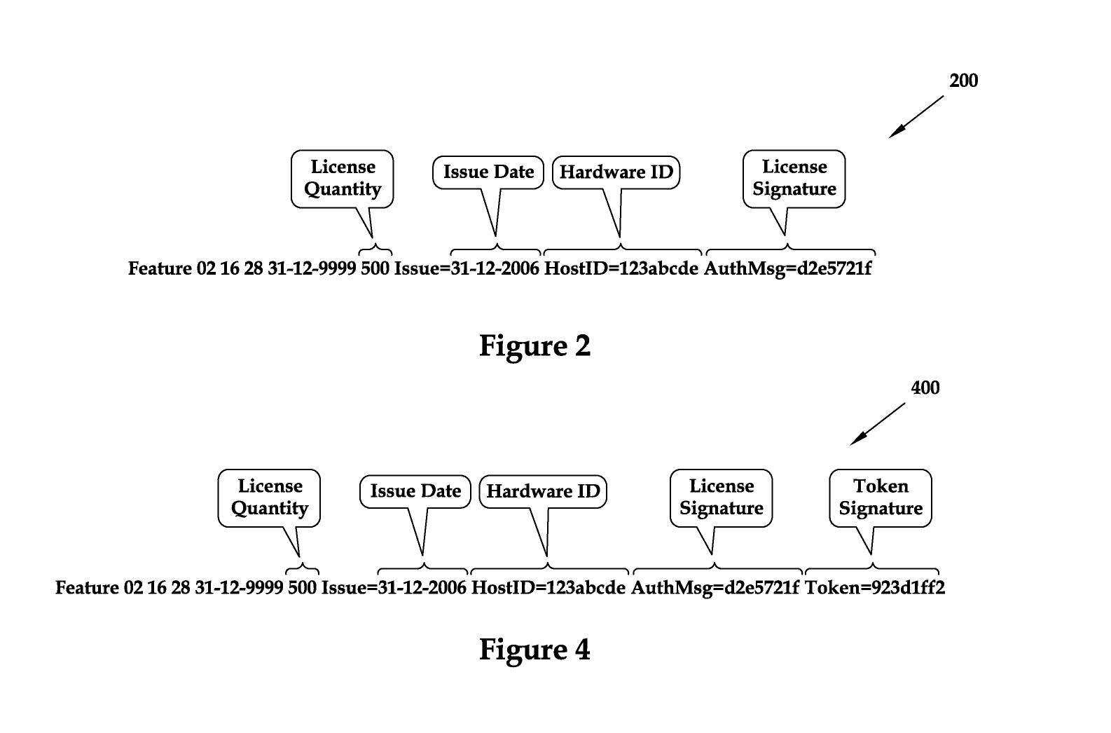

FIG. 2 conceptually illustrates one exemplary embodiment of a software license key 200. In the illustrated embodiment, the software license key 200 includes information (e.g., the numerical sequence 02 16 28 31-12-9999) indicating the features of the associated software that are enabled by the software license key 200. The software license key 200 also includes information indicating the number of licenses (e.g., 500 licenses) that have been granted by the software license key 200. An issue date or timestamp (e.g., 31-12-2006) is included in the software license key 200, as well as a hardware identifier (e.g., Host ID=123abcde) indicating the hardware that has the software installed and a license signature (e.g., AuthMsg=d2e5712f), which is encrypted information that is used to authenticate the software license key 200. The information included in the software license key 200 may be determined on the basis of subscription information, e.g., a subscription associated with a service provider operating one or more of the network elements that receive the software license key 200.

Referring back to FIG. 1, the license key generator 105 transmits the software license key 110 to a gateway 120, as indicated by the dashed arrow. In the illustrated embodiment, the license key generator 105 is communicatively coupled to an intranet 125 and the gateway 120 provides access to external networks. The network element 115 is a part of a customer intranet 130 and so the gateway 120 transmits the software license key 110 to a customer gateway 135 that provides access to the customer intranet 130. The software license key 110 is then transmitted from the customer gateway 130 to the network element 115, which determines whether or not to install the software license key 110.

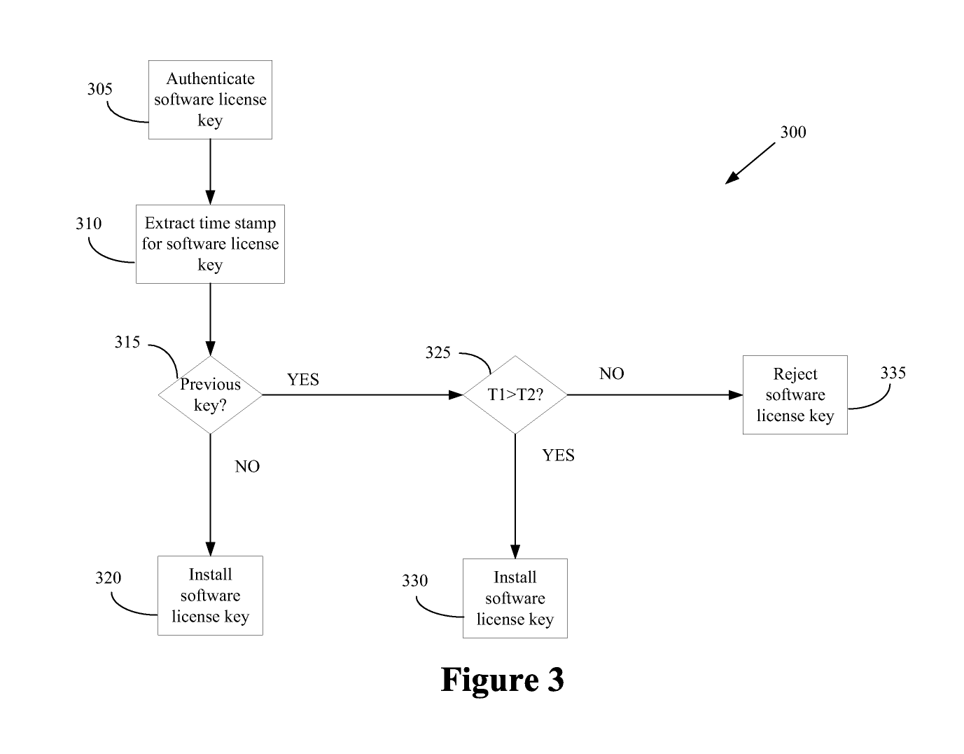

FIG. 3 conceptually illustrates one exemplary embodiment of a method 300 of determining whether to install a software license key on a network element. In the illustrated embodiment, the method 300 determines whether to install the software license key using a timestamp (or other information indicating a time and/or date that the software license key was issued) attached to or associated with the software license key. In one embodiment, the software installed on the network element uses an embedded key and an associated encryption algorithm to authenticate (at 305) the software license key received by the network element. If the software license key is authenticated (at 305), then the software may extract (at 310) the timestamp from the software license key. The software may then determine (at 315) whether any other software license keys have been previously installed. If no other software license key has been previously installed, then the software installs (at 320) the software license key so that the network element may operate in accordance with the features enabled by the software license key.

If another copy of a software license key has been previously installed, then the software compares (at 325) the timestamp associated with the software license key (T1) with the timestamp (T2) associated with the previously installed software license key. If the timestamp T1 indicates that the software license key was issued at a later time or date than the previously installed software license key, then the software license key is considered up-to-date and may be installed (at 330) on the network element. However, if the timestamp T1 indicates that the software license key was issued at an earlier time or date then the previously installed software license key, then the software license key may be considered out-of-date and may be rejected (at 335) for installation on the network element. The method 300 may therefore reduce the likelihood that an out-of-date software license key may be used inappropriately or fraudulently.

Referring back to FIG. 1, the network element 115 may generate a token 140 that is formed using information that may be used to verify that the software license key 110 was correctly installed on the network element 115. Persons of ordinary skill in the art having benefit of the present disclosure should appreciate that the token 140 may also be referred to as a “proof of purchase.” The token 140 may be formed using information included in the software license key 110 and may also include a token signature, such as a digital signature, that may be used to authenticate the token 140. The token signature may be formed using an embedded key and an associated encryption algorithm.

FIG. 4 conceptually illustrates one exemplary embodiment of a token 400. In the illustrated embodiment, the token 400 includes information derived from the software license key such as information (i.e., the numerical sequence 02 16 28 31-12-9999) indicating the features of the associated software that are enabled by the software license key 200. The token 400 also includes information indicating the number of licenses (e.g., 500 licenses) that was granted by the software license key, an issue date or timestamp (e.g., 31-12-2006) that was included in the software license key, hardware identifier (e.g., Host ID=123abcde) and a license signature (e.g., AuthMsg=d2e5712f). The token 400 also includes a token signature (e.g., Token=923d1ff2), which is encrypted information that is used to authenticate the token 400 and protect the integrity of the token 400, e.g., the token signature may be used to determine whether the token 400 has been altered by an unauthorized third party.

Referring back to FIG. 1, the network element 115 may transmit the token 140 to an e-mail server 145 in the customer intranet 135. The e-mail server 145 may transmit the token 140 to the customer gateway 130, which may forward the token 140 to a token verifier 150 via the gateway 120. The token verifier 150 may then verify and/or authenticate the token 140. If the token verifier 150 successfully verifies and/or authenticate the token 140, and the operator of the license key generator 105 may determine that the software license key 110 has been successfully installed on the network element 115.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
transmitting a first software license key and a first timestamp towards a network element that has software installed thereon, the first software license key comprising information used to enable a portion of the functionality of the software, and the network element being configured to install the first software license key when the first timestamp indicates a time later than a second timestamp associated with a second software license key installed on the network element.

2. The method of claim 1, comprising forming the first software license key based on subscription information from a service provider associated with the network element.

3. The method of claim 2, wherein forming the first software license key comprises forming a first software license key that enables a portion of the functionality of the software indicated by the subscription information.

4. The method of claim 1, comprising receiving, in response to transmitting the software license key and the associated timestamp, encrypted information formed using the first software license key and the first time stamp.

5. The method of claim 4, comprising decrypting the encrypted information formed using the first software license key and the first time stamp.

6. The method of claim 5, comprising verifying that the first software license key was correctly installed based on the information indicative of the first software license key and the first timestamp included in the decrypted information.

7. The method of claim 1, comprising determining that the first software license key was not correctly installed in response to failing to receive, in response to transmitting the software license key and the associated timestamp, encrypted information formed using the first software license key and the first timestamp.

8. A method, comprising:
receiving a first software license key and a first timestamp associated with software, the first software license key comprising information used to enable a portion of the functionality of the software; and
installing the first software license key when the first timestamp indicates a time later than a second timestamp associated with a previously installed second software license key associated with the software.

9. The method of claim 8, wherein receiving the first software license key comprises receiving a first software license key based on subscription information indicative of the portion of the software enabled by the first software license key.

10. The method of claim 8, comprising determining whether the first timestamp indicates a time later than the second timestamp.

11. The method of claim 10, comprising installing the first software license key in response to determining that the first timestamp indicates a time later than the second timestamp.

12. The method of claim 11, comprising forming encrypted information using the first software license key and the first timestamp in response to determining that the first timestamp indicates a time later than the second timestamp.

13. The method of claim 12, comprising transmitting the encrypted information formed using the first software license key and the first time stamp.

14. The method of claim 10, comprising rejecting installation of the first software license key in response to determining that the first timestamp indicates a time earlier than the second timestamp.
